(19) United States
(12) Patent Application Publication
(10) Pub. No.: US 2016/0154684 A1
(43) Pub. Date: Jun. 2, 2016

(54) DATA PROCESSING SYSTEM AND DATA PROCESSING METHOD

(71) Applicant: HITACHI, LTD., Tokyo (JP)

(72) Inventor: Takuya KUSU, Tokyo (JP)

(73) Assignee: HITACHI, LTD., Chiyoda-ku, Tokyo (JP)

(21) Appl. No.: 14/906,650

(22) PCT Filed: Feb. 19, 2014
(86) PCT No.: PCT/JP2014/053874

§ 371 Date: Jan. 21, 2016

(51) Int. Cl. G06F 9/52

(52) U.S. Cl. CPC G06F 9/52

(57) ABSTRACT

A data processing system comprising: a first storage device which stores, as input data, divisional data which is divided into a plurality of sets of the same type of data, each set having a respective size; a child job generation unit which, when the plurality of sets of data have been stored in the first storage device, generates child jobs on the basis of a parent job for processing the plurality of sets of data; a child job activation unit which activates the child jobs generated by the child job generation unit; and a second storage device which stores sets of output data resulting from the execution of the child jobs, each set of output data corresponding to one of the plurality of sets of data.

### TECHNICAL FIELD

The present invention relates to a data processing system and a data processing method, and more particularly to a parallel processing technique of the same type of a large amount of data.

### BACKGROUND ART

In recent years, in order to utilize the same type of a large amount of data called big data, an attempt to analyze the data has been made. Efficient data processing techniques of a large amount of data include a parallel processing technique.

The parallel processing techniques are disclosed, for example, in Patent Documents 1 and 2. Patent Document 1 discloses a data processing system that performs control such that, when a plurality of different workflows are executed, parallel executable processes of a plurality of workflows are executed in parallel, and an exclusive process such as a printing process is executed according to a data input order to the exclusive process of a plurality of workflows.

Patent Document 2 discloses a pseudo parallel process in which transmission and reception data is divided, a communication process is executed for each divisional data, and another process is executed while the communication process of each divisional data is being executed.

### CITATION LIST

### Patent Document

Patent Document 1: JP 2010-9200 A

Patent Document 2: JP H9-185568 A

### SUMMARY OF THE INVENTION

### Problems to be Solved by the Invention

For example, processes of the same type of a large amount of data include the following processes. A data processing system that collectively aggregates and analyzes data of municipalities in units of municipalities such as prefectures or for the whole country is known. As another example, a data processing system that concentrates on data collection and analysis, for example, for marketing of companies that compete in the global market is known. In this data processing system, it is necessary to repeatedly perform the same processes such as aggregation and analysis on the same type of data (records having the same data item), and it is desirable to reduce a processing time associated with repetition of the same processes.

It is difficult to apply the parallel processing techniques of Patent Documents 1 and 2 to the data processing system. It is because the parallel processing techniques of Patent Documents 1 and 2 are a parallel processing technique of executing different processes in parallel. The technique disclosed in Patent Document 1 is a technique of executing a plurality of different workflows in parallel, and parallel execution of the same processes intended for the same type of data is not considered. The technique disclosed in Patent Document 2 is a parallel process of the communication process and another process, and similarly to the technique disclosed in Patent Document 1, parallel execution of the same processes intended for the same type of data is not considered.

In the data processing system that aggregates and analyzes a large amount of data, data processing is executed daily (once a day), monthly, annually, or the like, but in the former example, a situation in which data from a municipality is not necessarily prepared at a predetermined date and time according to a state of a system of a municipality or a network from a municipality to the data processing system arises. In the latter example, a situation in which data is not prepared at a predetermined time due to a time difference of continents or countries in the world arises. Further, when necessary data is prepared at a given time, it is desirable that the data processing system avoid an overload state in which large capacity memories and CPU capabilities are temporarily used for aggregation and analysis.

In this regard, in order to deal with the situation in which the same type of a large amount of data is sequentially prepared or in order to avoid the temporal overload state, a data processing system capable of efficiently executing data processing is necessary. Here, “efficient” means reducing a processing delay of a target data while suppressing a peak load of a data processing system.

### Solutions to Problems

A data processing system according to the present disclosure includes a first storage device that stores a plurality of pieces of divisional data obtained by dividing the same type of data in predetermined units as input data, a child job generation unit that generates a child job based on a parent job of executing a process on each of the divisional data in response to storage of each of the plurality of pieces of divisional data in the first storage device, a child job activation unit that activates the child job generated by the child job generation unit, and a second storage device that stores output data corresponding to each of the divisional data according to execution of the child job.

### Effects of the Invention

According to the present invention, is possible to provide a data processing system capable of efficiently processing the same type of a large amount of data.

### BRIEF DESCRIPTION OF THE DRAWINGS

FIG. 1 illustrates an exemplary configuration of a data processing system.

FIG. 2 illustrates an exemplary configuration of a job execution management table.

FIG. 3 is a state transition diagram for managing a processing state of a child job.

FIG. 4 is a processing flowchart of a parallel execution control unit.

FIG. 5 illustrates an example of a workflow of cascade and integration processes.

### MODE FOR CARRYING OUT THE INVENTION

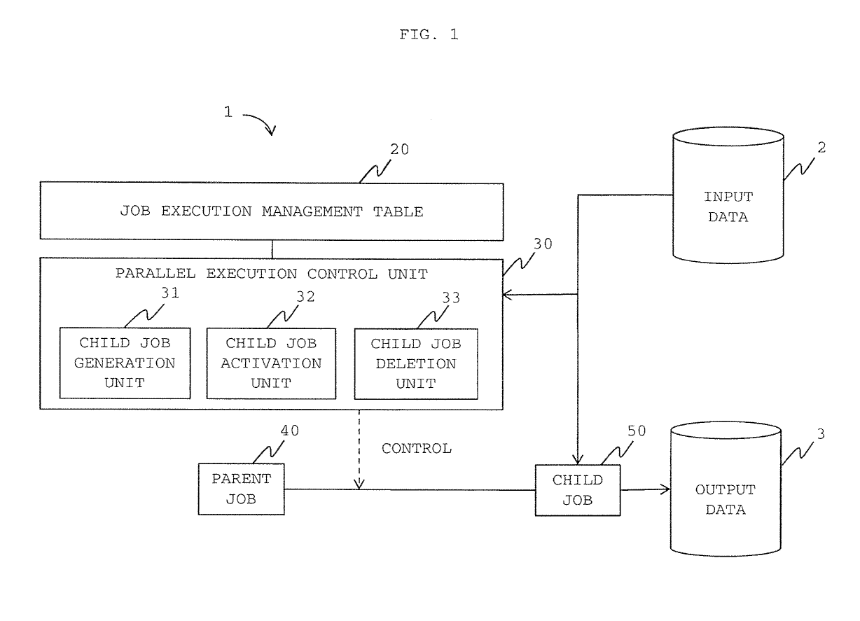

FIG. 1 illustrates an exemplary configuration of a data processing system 1 according to an embodiment. The data processing system 1 efficiently executes data processing through a parallel process and thus is also called a parallel processing system. The data processing system 1 is a system that executes data processing on input data 2 prepared in a storage device and outputs output data 3 to the storage device. Processing content executed by the data processing system 1 is a predetermined process (for example, a statistical process of aggregating input data and calculating a grand total, an average value, or the like or a mining process intended for input data).

The input data 2 is transmitted from another system (a computer, a terminal, or the like) via a network (not illustrated) and stored in the storage device. The reception of the data transmitted from another system and the storage of the data to the storage device may be executed by a processing unit (not illustrated) of the data processing system 1 or may be executed by another system sharing the storage device.

The input data 2 is divided for each of other systems that transmit data (in predetermined units). For example, the input data 2 is divided into divisional data A serving as data from another system A and divisional data B serving as data from another system B. A specific example will be described. If the input data 2 is data transmitted from systems of municipalities (cities, towns, and villages), data transmitted from a system A of a municipality A is divisional data A, and data transmitted from a system B of a municipality B is divisional data B. As is obvious from this example, since the input data 2 is target data of an aggregation process or the like, the divisional data A and the divisional data B are generally different in the number of data (the number of records) but the same in items configuring data (a record) and a format thereof. In other words, respective pieces of divisional data are the same type of data having the same record configuration but different in content (a substance of data and the number of records).

A parallel execution control unit 30 of the data processing system 1 checks a preparation state of the input data 2, and stores a check result in a job execution management table 20. The parallel execution control unit 30 checks the preparation state of the input data 2 through a notification given from another system that prepares divisional data.

The job execution management table 20 is a table for managing the preparation state of the input data 2 and a data processing execution state. A parent job 40 is a job (here, it is referred to as a job, but it is software of executing a predetermined process and may be referred to as a process or the like) for a predetermined process which is described above, and data processing is executed on the input data 2 in which the child job 50 generated based on the parent job 40 is prepared and output to the storage device as the output data 3.

The parallel execution control unit 30 controls a child job generation unit 31 according to the preparation state of the input data 2 indicated by the job execution management table 20 such that the child job 50 is generated based on the parent job 40, and controls a child job activation unit 32 such that the child job 50 is activated. Further, the parallel execution control unit 30 monitors a processing state of the child job 50, and stores the monitoring result in the job execution management table 20. When the child job 50 completes execution of a predetermined process, and the child job 50 is unnecessary, the parallel execution control unit 30 controls a child job deletion unit 33 such that an unnecessary child job 50 is deleted.

In the present embodiment, the description proceeds with an example of generating the child job 50 from the parent job 40 and causing the generated child job 50 to execute a predetermined process, but when the data processing system 1 is constructed by a virtual server system, a virtual server may be generated as one corresponding to the child job 50 to be generated, and the generated virtual server may be caused to execute a predetermined process. Further, when the data processing system 1 is constructed by a multi-server system, the child job 50 may be generated in each of servers configuring the multi-server system, and when computer resources such as a CPU or a memory are sufficient as a whole, the child job 50 may be generated in each server in advance, and the generated child job 50 may be activated. However, when the data processing system 1 is constructed by the multi-server system, the data processing system 1 is constructed so that the storage device storing the input data 2 and the output data 3 is shared with another system which is described above and shared by the servers configuring the multi-server system. As described above, it is desirable to construct the data processing system 1 suitable for a computer environment according to various computer environments.

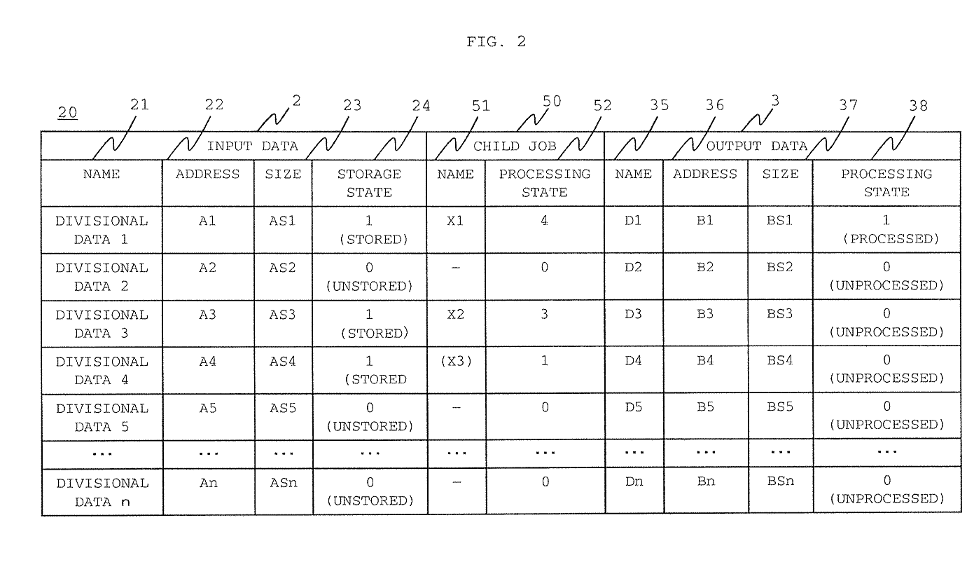

FIG. 2 illustrates an exemplary configuration of the job execution management table 20. Each of lines of the job execution management table 20 corresponds to divisional data configuring the input data 2. A name 21 of the input data 2 is a name serving as an identifier identifying each divisional data. The input data 2 is managed according to an address 22 of the storage device in which divisional data is being stored or to be stored, a size (the number of records) 23 of each divisional data, and a storage state 24 in association with the name 21 of each divisional data. The address 22 of the storage device in which divisional data is being stored or to be stored is an address of the storage device in which another system stores divisional data or another system has stored divisional data.

The address 22 is decided for each of other systems that store divisional data in advance. Here, “decided in advance” does not necessarily means “fixed,” another system and the data processing system 1 may recognize the address 22 of the storage device corresponding to the name 21 of each divisional data in common before another system stores divisional data, or the address 22 may be decided such that an area storing divisional data is dynamically secured.

Further, when each divisional data is stored in the storage device as a file (when a so-called file system is used), it depends on the file system by replacing the name 21 with a file name and the address 22 with a path to a file, but a degree of freedom of a storage address (a storage area) of each divisional data improves and there is no need to be decided for each of other systems in advance.

There are cases in which the size 23 is fixed for each of other systems according to data processed by the data processing system 1, but the address 22 is set to be variable, and the size (the number of records) of stored divisional data is stored at the stage at which another system stores divisional data.

The storage state 24 indicates a storage state of divisional data in the storage device and is set to 0 (unstored) or 1 (stored) by the parallel execution control unit 30 that has received a divisional data storage completion notification from another system at the stage at which another system completes storage of divisional data in the storage device as the input data 2. The parallel execution control unit 30 may set the storage state 24 to 1 (stored) or 0 (unstored) collectively for all pieces of divisional data at a predetermined time or when a predetermined data process on the input data 2 is completed, but the parallel execution control unit 30 is assumed to set the storage state 24 to 1 (stored) or 0 (unstored) here when a predetermined data process by the child job 50 on each divisional data is completed.

The processing state of the child job 50 that executes a predetermined data process is managed by a name 51 and a processing state 52 of the child job 50 in association with the name 21 of each divisional data of the job execution management table 20. The processing state of the child job 50 will be described later, but the parallel execution control unit 30 that has received a notification indicating the state from the child job 50 sets the notified state as the processing state 52. It is similar to one in which the parallel execution control unit 30 that has received the divisional data storage completion notification from another system sets the storage state 24.

Further, a setting of the storage state 24 by another system and a setting of the processing state 52 of the child job 50 by the child job 50 are possible, but since a plurality of processing units (the parallel execution control unit 30, a processing unit of another system, and the child job 50) are allowed to access the job execution management table 20, in order to prevent the control from being complicated, the parallel execution control unit 30 is here assumed to receive a notification and set the storage state 24 or the processing state 52. The same applies to a processing state 38 of the output data 3 which will be described later. When information such as an address and a size is received from another system or the child job 50 (the parallel execution control unit 30 does not have the information such as when the storage area is dynamically secured) as the storage state 24 or the processing state 52 is set, a notification including the information is received.

The output data 3 is managed by an address 36 of the storage device in which divisional data is being stored or to be stored, a size (the number of records) 37 of each divisional data, and the processing state 38 in association with the name of each divisional data. The address 36 and the size 37 related to the output data 3 are similar to the address 22 and the size 23 related to the input data 2, and thus a description thereof is omitted. The processing state 38 indicates a state 0 (unprocessed) in which the child job 50 has not completed a predetermined process on divisional data or a state 1 (processed) in which the child job 50 has completed a predetermined process on divisional data in association with the storage state 24 related to the input data 2. As described above, the processing state 38 is set by the parallel execution control unit 30 that has received a notification from the child job 50. A setting change from 0 (unprocessed) to 1 (processed) or from 1 (processed) to 0 (unprocessed) by the parallel execution control unit 30 can be understood by replacing the storage related to the input data 2 with the process related to the output data 3 in the above description, and thus a description thereof is omitted.

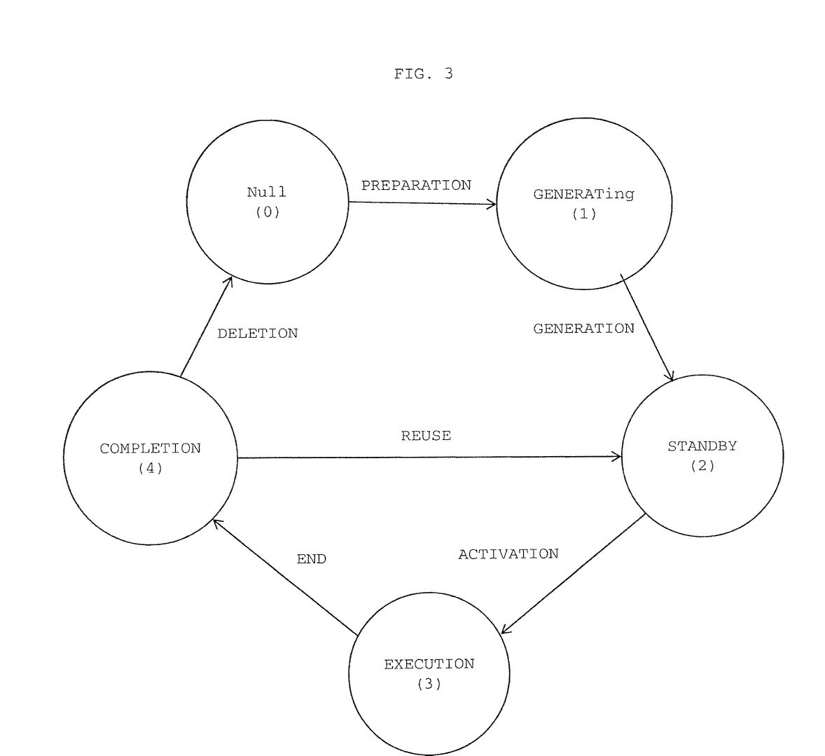

FIG. 3 is a state transition diagram for managing the processing state 52 of the child job 50 through the parallel execution control unit 30. A state in which the child job 50 is not generated in association with divisional data is a Null state (0). In the state (0), the child job 50 has no name, and in the job execution management table 20 of FIG. 2, the name 51 is indicated by “- (hyphen),” (0) is as the processing state 52.

The parallel execution control unit 30 activates the child job generation unit 31 in associated with stored divisional data, and causes the processing state 52 to transition from the Null state (0) to a generating state (1). The activated child job generation unit 31 generates the child job 50 from the parent job 40 in association with the stored divisional data, gives a notification indicating the generation of the child job 50 to the parallel execution control unit 30, and in response to the notification, the parallel execution control unit 30 gives a name to the child job 50, sets the name to the name 51, and causes the processing state 52 to transition from the generating state (1) to a standby state (2).

The parallel execution control unit 30 checks (sets if necessary) 0 (unprocessed) of the processing state 38 of the output data 3, controls the child job activation unit 32 using the address 22 and the size 23 of the divisional data corresponding to the generation of the child job 50 and a name 35 and the address 36 of the output data 3 corresponding to the divisional data as parameters such that the child job 50 in the standby state (2) is activated, and causes the processing state to transition from the standby state (2) to an execution state (3). The size 37 of the output data 3 corresponding to the divisional data is included in a process end notification from the child job 50 and thus set in association with the notification by the parallel execution control unit 30.

The activated child job 50 executes a predetermined data process on the divisional data with reference to the address 22 and the size 23 of the parameters, and stores the output data 3 serving as the process result in the storage device with reference to the name 35 and the address 36 of the parameters. After the output data 3 is stored in the storage device, the child job 50 gives a process end notification that includes the stored size (the number of records) to the parallel execution control unit 30. The parallel execution control unit 30 that has received the notification sets the size included in the notification to the size 37, causes the processing state 38 of the output data 3 to transition from 0 (unprocessed) to 1 (processed), and causes the processing state 52 of the child job 50 to transition from the execution state (3) to a completion state (4).

After causing the processing state 52 of the child job 50 to transition to the completion state (4), the parallel execution control unit 30 checks whether or not there is divisional data in which the storage state 24 of the input data 2 indicated by the job execution management table 20 is 1 (stored), and the processing state 52 of the child job 50 is the Null state (0), sets the name of the child job 50 to the name 51 corresponding to the checked divisional data when there is the divisional data, and causes the processing state 52 to transition from the completion state (4) to the standby state (2). A process after transition to the standby state (2) is the same as one described above.

Further, when the processing state 52 of the child job 50 transitions from the completion state (4) to the standby state (2), and the child job 50 is reused, strictly, it is checked not only whether or not there is divisional data in which the processing state 52 of the child job 50 is the Null state (0), but also that the child job generation unit 31 has not been activated in order to generate the child job 50 corresponding to the divisional data. Otherwise, the child job 50 is likely to be double generated for the same divisional data.

When there is no divisional data in which the storage state 24 of the input data 2 is 1 (stored), and the processing state 52 of the child job 50 is the Null state (0), the child job 50 in the completion state (4) is unnecessary, and the child job deletion unit 33 is controlled such that the unnecessary child job 50 is deleted.

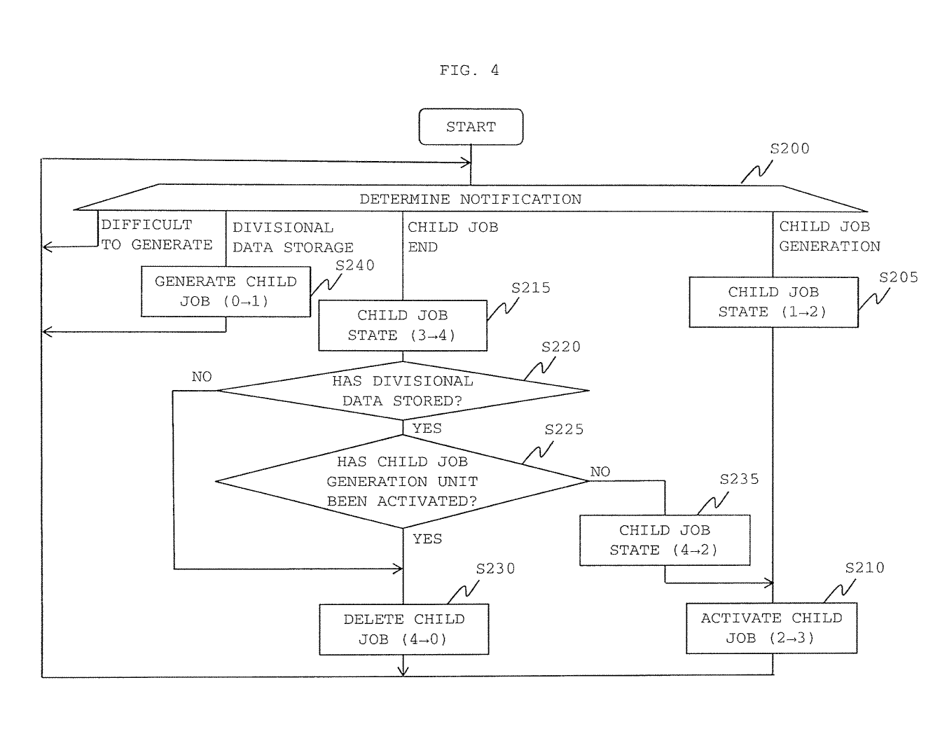

FIG. 4 is a processing flowchart of the parallel execution control unit 30. The parallel execution control unit 30 determines whether or not a notification has been received (S200). As described above, examples of the notification include the divisional data storage completion notification given from another system, the process end notification given from the child job 50, and the generation notification of the child job 50 given from the child job generation unit 31. In addition, there is a notification related to an abnormality process such as a notification indicating that it is difficult to generate the child job 50 and is given from the child job generation unit 31, but this notification is omitted here.

There are cases in which the parallel execution control unit 30 receives the notifications at the same time. The same time means that there are cases in which a plurality of notifications are detected in the process of determining whether or not the notification has been received and is not limited to a case in which notifications are necessarily given at the same time. In order to deal with this case, an order of child job generation, child job end, and divisional data storage is assumed to be a notification determination order (priority). According to the determination order, for example, if the child job generation notification and the child job end notification are given, the process corresponding to the child job generation notification ends, then the process returns to the process (S200) of determining whether or not the notification has been received, and at this time, the child job end notification remains.

In response to the detection of the generation notification of the child job 50 given from the child job generation unit 31, the parallel execution control unit 30 causes the processing state 52 of the child job 50 corresponding to the divisional data and serving as the control factor of the child job generation unit 31 to transition from the generating state (1) to the standby state (2) (S205), controls the child job activation unit 32 such that the generated child job 50 is activated, and causes the processing state 52 to transition from the standby state (2) to the execution state (3) (S210).

In response to the detection of the end notification given from the child job 50, the parallel execution control unit 30 sets the size included in the notification to the size 37 in association with the divisional data on which the child job 50 has ended the process, causes the processing state 38 of the output data 3 to transition from 0 (unprocessed) to 1 (processed), and causes the processing state 52 of the child job 50 to transition from the execution state (3) to the completion state (4) (S215).

The parallel execution control unit 30 determines whether or not there is divisional data in which the storage state 24 is 1 (stored) (S220). When there is the divisional data, it is determined whether or not the processing state 52 of the corresponding child job 50 is the generating state (1) (S225). When there is no divisional data in which the storage state 24 is 1 (stored) or when there is the divisional data in which the storage state 24 is 1 (stored) but the processing state 52 of the corresponding child job 50 is the generating state (1), the parallel execution control unit 30 controls the child job deletion unit 33 such that the child job 50 from which the end notification is given is deleted, and causes the processing state 52 of the child job 50 to transition from the completion state (4) to the Null state (0) (S230). At this time, the name of the deleted child job 50 is deleted as well (it is indicated by “- (hyphen)” in FIG. 2).

On the other hand, when there is the divisional data in which the storage state 24 is 1 (stored) but the processing state 52 of the corresponding child job 50 is not the generating state (1), the parallel execution control unit 30 causes the processing state 52 of the child job 50 to transition from the completion state (4) to the Null state (0) in association with the divisional data in which the process has ended, deletes the name 51 of the child job 50, gives the name 51 of the child job 50 in association with the divisional data in which the storage state 24 is 1 (stored), causes the processing state 52 to transition from the completion state (4) to the standby state (2) (S235), further controls the child job activation unit 32 such that the child job 50 in the standby state is activated, and causes the processing state 52 to transition from the standby state (2) to the execution state (3) (S210).

In response to the divisional data storage completion notification given from another system, the parallel execution control unit 30 sets the size included in the storage completion notification to the size 23 corresponding to the stored divisional data, and causes the storage state 24 to transition from 0 (unstored) to 1 (stored). The parallel execution control unit 30 activates the child job generation unit 31, gives the name 51 of the child job corresponding to the stored divisional data, and causes the processing state 52 to transition from the Null state (0) to the generating state (1) (S240). When none of the notifications are detected, the notification determination (S200) is repeated.

The basic configuration and operation have been described above. As described above, it is possible to provide the data processing system capable of efficiently processing the same type of a large amount of data. In order to deal with the situation in which the same type of a large amount of data is sequentially prepared, the process is executed according to the preparation state of the divisional data, and thus it is possible to reduce the process delay of the target data while suppressing the peak load of the data processing system.

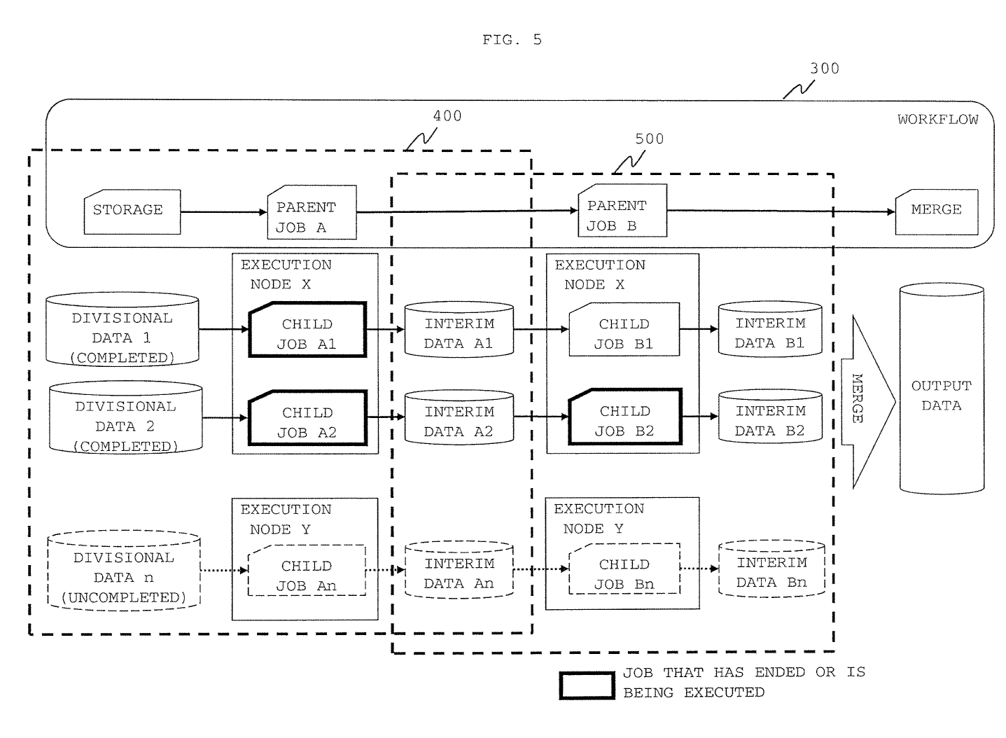

Next, a more practical example of executing the process on the divisional data in a cascade manner and executing an integration process on the whole output data of the respective divisional data finally will be described. FIG. 5 illustrates an example of the flow of the cascade and integration processes.

FIG. 5 is an example of a workflow 300 of the cascade and integration processes, that is, an example of the flow of outputting final output data through a process block A400, a process block B500, and a merge process. The process block A400 executes a job A (a child job Ai generated based on a parent job A) on divisional data i serving as the input data 2 stored in the storage device from another system, outputs interim data Ai as the output data 3, and is managed by the parallel execution control unit 30 using the job execution management table 20 illustrated in FIG. 2, and thus a basic configuration and operation thereof are similar to those described above. The process block 3500 executes a job B (a child job Bi generated based on a parent job B of executing a process different from the parent job A) on the interim data Ai serving as the input data 2 stored in the storage device from the job A, and outputs interim data Bi as the output data 3 and has a similar configuration and operation as those of the process block A400.

As described above, in a portion of the process block regarded as the cascade configuration, a basic configuration and operation are repeated, and thus a description thereof is omitted. However, it is necessary to replace the terms used in the description of the job execution management table 20. In the process block B500, since the processing state 38 of the output data 3 associated with the execution of the job A is dealt as the input data 2 from the job A, it is necessary to replace it with the storage state 24.

In the workflow 300, an example of outputting final output data by merging is illustrated, but the present invention is not limited to the merging, and final output data may be obtained by a process of obtaining an average or a variance or a process of obtaining a grand total for the interim data Bi (i=1 to n). The process related to integration of the interim data cannot be executed unless all interim data are prepared, and thus it is necessary to wait for interim data whose preparation state is delayed. Activation of a job of detecting that interim data is prepared and executing the integration process is controlled by the parallel execution control unit 30.

There are cases in which the integration process is performed on partial interim data. For example, there are cases in which the divisional data is data transmitted from systems of municipalities (cities, towns, and villages) in the above example, data corresponding to prefectures is obtained as interim integrated data, and integrated data for the whole country is output for data corresponding to the prefectures in some cases. In this case, when integration process target data of municipalities of prefectures is prepared, the integration process can be executed in units of prefectures. As the integration process is executed step by step as described above, it is possible to reduce the process delay of the target data while suppressing the peak load of the data processing system.

When a job is partially executed (executed by a child job) in association with divisional data as described above, an administrator of this process needs to see an overall process progress (a workflow progress). The reason that partial execution is not performed is not necessarily because the divisional data is not prepared, but may be because a failure occurs in a computer executing a job.

For this reason, the data processing system 1 includes an input/output device (not illustrated). Commonly, for example, the parallel execution control unit 30 causes the diagram illustrating the flow of the process illustrated in FIG. 5 to be displayed on a screen of the input/output device. When the divisional data is prepared, a child job corresponding to the divisional data that has been executed or is being executed is displayed in a different form (for example, in a different color), and thus visibility of the progress of the workflow by the administrator can be improved. Further, when timestamps such as a storage time of divisional data and an output time of interim data are displayed in association with respective data display positions on the screen, the administrator can easily recognize an abnormal process delay. Although the timestamp has not been mentioned, the timestamp can easily be implemented by setting a time associated with storage or process completion to the storage state 24 and the processing state 52 of the job execution management table 20 or time information columns added corresponding to the storage state 24 and the processing state 52.

A display focused on an abnormal process delay other than an overall process progress is also necessary. Since the job execution management table 20 corresponding to the process blocks illustrated in FIG. 5 can be considered to be present (actually, for example, in order to remove overlapping related to the interim data Ai of FIG. 5, the job execution management table 20 is configured as the overall process, and a part corresponding to the process block is extracted from that), the parallel execution control unit 30 causes the job execution management table 20 corresponding to a designated process block to be displayed on the input/output device in response to an input (pointing by a mouse or the like) by the administrator designating a screen display process block indicating the flow of the process illustrated in FIG. 5. The administrator can check the processing state 52 of the child job 50 as the job execution management table 20 is displayed and thus can easily deal with the abnormal process delay or the like.

Drawings and a detailed description related to an input and output associated with the progress management of the workflow 300 by the administrator are omitted, but the input and output can easily be implemented by those having ordinary skill in the art to which the present embodiment pertains.

According to the present embodiment described above, it is possible to provide the data processing system capable of efficiently processing the same type of a large amount of data.

### REFERENCE SIGNS LIST

1 Data processing system
2 Input data
3 Output data
20 Job execution management table
30 Parallel execution control unit
31 Child job generation unit
32 Child job activation unit
33 Child job deletion unit
40 Parent job
50 Child job

1. A data processing system, comprising:
a first storage device that stores a plurality of pieces of divisional data obtained by dividing the same type of data in predetermined units as input data;
a child job generation unit that generates a child job based on a parent job of executing a process on each of the divisional data in response to storage of each of the plurality of pieces of divisional data in the first storage device;
a child job activation unit that activates the child job generated by the child job generation unit; and
a second storage device that stores output data corresponding to each of the divisional data according to execution of the child job.

2. The data processing system according to claim 1, further comprising,
a parallel execution control unit that controls the child job generation unit and the child job activation unit.

3. The data processing system according to claim 2,
wherein the parallel execution control unit further controls a child job deletion unit that deletes the child job in response to an end of the execution of the child job of executing a process on each of the divisional data.

4. The data processing system according to claim 3,
wherein the plurality of pieces of divisional data are stored in the first storage device from different other systems.

5. The data processing system according to claim 4,
wherein, when processes of executing a process on each of the divisional data form a cascade configuration, a process block is formed in association with each of the processes forming the cascade configuration, and the parent job is provided in association with the process of each of the process blocks.

6. The data processing system according to claim 5, further comprising,
an input/output device that displays the input data, the child job, and the output data in association with each of the divisional data, and displays the child job that has been executed and the child job that is being executed in a form different from the other child jobs.

7. The data processing system according to claim 6,
wherein the input/output device displays the process block to be superimposed on the displayed input data, child job, and output data, and in response to designation and input of the process block from the input/output device, the parallel execution control unit causes storage states of the input data and the output data and a processing state of the child job corresponding to the designated and input process block to be displayed on the input/output device.

8. A data processing method in a data processing system including a first storage device that stores a plurality of pieces of divisional data obtained by dividing the same type of data in predetermined units as input data and a second storage device that stores output data of a process executed in association with each of the divisional data, the data processing method comprising:
generating, by the data processing system, a child job based on a parent job of executing a process on each of the divisional data in response to storage of each of the plurality of pieces of divisional data in the first storage device;
activating, by the data processing system, the generated child job; and
storing, by the data processing system, the output data corresponding to each of the divisional data according to execution of the child job in the second storage device.

9. The data processing method according to claim 8,
wherein the data processing system controls generation and activation of the child job, and controls deletion of the child job in response to an end of execution of the child job of executing a process on each of the divisional data.

10. The data processing method according to claim 9,
wherein the plurality of pieces of divisional data are stored in the first storage device from different other systems.

11. The data processing method according to claim 10,
wherein, when processes of executing a process on each of the divisional data form a cascade configuration, the data processing system forms a process block association with each of the processes forming the cascade configuration, and has the parent job in association with the process of each of the process blocks.

12. The data processing method according to claim 11,
wherein the data processing system causes the input data, the child job, and the output data to be displayed on an input/output device in association with each of the divisional data, and causes the child job that has been executed and the child job that is being executed to be displayed on the input/output device in a form different from the other child jobs.

13. The data processing method according to claim 12,
wherein the data processing system displays the process block to be superimposed on the input data, the child job, and the output data displayed on the input/output device, and in response to designation and input of the process block from the input/output device, the data processing system causes storage states of the input data and the output data and a processing state of the child job corresponding to the designated and input process block to be displayed on the input/output device.
